(19) United States
(12) Patent Application Publication
(10) Pub. No.: US 2017/0300877 A1
(43) Pub. Date: Oct. 19, 2017

(54) SYSTEM AND METHOD FOR PROVIDING SHARED HASH ENGINES ARCHITECTURE FOR A BITCOIN BLOCK CHAIN

(71) Applicant: Spondoolies Tech Ltd., Kiryat Gat (IL)

(72) Inventors: Omri MANN, Jerusalem (IL); Zvi SHTEINGART, Jerusalem (IL)

(21) Appl. No.: 15/513,175

(22) PCT Filed: Sep. 21, 2015
(86) PCT No.: PCT/IL2015/050959

§ 371 Date: Mar. 22, 2017

Related U.S. Application Data
(60) Provisional application No. 62/053,833, filed on Sep. 23, 2014.

(51) Int. Cl. G06Q 20/06; H04L 9/06; G06F 17/30; H04L 9/32

(52) U.S. Cl. CPC G06Q 20/0655; H04L 9/3247; H04L 9/3239; G06F 17/30949; H04L 9/0637; H04L 9/0643; G06Q 2220/00

(57) ABSTRACT

A method and system for sharing hash calculations across N parallel mining threads, the method comprising: finding N Merkle root hash values that have identical marginal portions of a predetermined size, calculating a corresponding mid-state hash for each of the N Merkle root hash values, and transmitting the N Merkle root hash values along with the corresponding mid-state values to the N parallel mining threads.

### FIELD OF THE INVENTION

The present invention relates to implementing bitcoin block chain, and more particularly, to implementing same in an efficient shared engines architecture.

### BACKGROUND OF THE INVENTION

The most important part of the bitcoin system is a public ledger that records financial transactions in bitcoins. This is accomplished without the intermediation of any single, central authority, as long as mining is decentralized. Instead, multiple intermediaries exist in the form of computer servers running bitcoin software. By connecting over the Internet, these servers form a network that anyone can join. Transactions of the form: “payer X wants to send Y bitcoins to payee Z” are broadcast to this network using readily available software applications. Bitcoin servers can validate these transactions, add them to their copy of the ledger, and then broadcast these ledger additions to other servers.

Bitcoin transactions are permanently recorded in a public distributed ledger called the block chain. Approximately six times per hour, a group of accepted transactions, a block, is added to the block chain, which is quickly published to all network nodes. This allows bitcoin software to determine when a particular bitcoin amount has been spent, a novel solution for preventing double-spends in a peer-to-peer environment with no central authority. Whereas a conventional ledger records the transfers of actual bills or promissory notes that exist apart from it, the block chain is the only place that bitcoins can be said to exist. To independently verify the chain-of-ownership of any and every bitcoin amount, full-featured bitcoin software stores its own copy of the block chain.

Maintaining the block chain is referred to as “mining” and those who do are rewarded with newly created bitcoins and transaction fees. Miners may be located anywhere in the world; they process payments by verifying each transaction as valid and adding it to the block chain. Today, payment processing is rewarded with 25 newly created bitcoins per block added to the block chain. To claim the reward, a special transaction called a coinbase is included with the processed payments. All bitcoins in circulation can be traced back to such coinbase transactions. The bitcoin protocol specifies that the reward for adding a block will be halved approximately every four years. Eventually, the reward will be removed entirely when an arbitrary limit of 21 million bitcoins is reached circa 2140, and transaction processing will then be rewarded by transaction fees solely.

Recently, mining has become very competitive, and ever more specialized technology is utilized. The most efficient mining hardware makes use of custom designed application-specific integrated circuits (ASIC), which outperform general purpose CPUs and use less power as well. Without access to these purpose built machines, a bitcoin miner is unlikely to earn enough to even cover the cost of the electricity used in his or her efforts.

Bitcoin block chain consists of transactions that need to be executed that are preceded by header. All the transactions are signed using a Merkle Tree implementation and the signature is embedded in the block header, the block header also needs to be signed by double hash that meets certain conditions in order to become a valid signature that is accepted by the network.

A Merkle tree is a binary tree that is used in bitcoin to summarize all the transactions in a block, producing an overall digital fingerprint of the entire set of transactions. A Merkle tree is constructed by recursively hashing pairs of nodes until there is only one hash, called the root, or Merkle root.

A bitcoin block chain holds the actual transactions and is signed by signing the transactions and the header. The header is the heart of all the bitcoin mining mechanism and is used in order to secure the bitcoin by design as well as driving bitcoin mining efforts.

The mining algorithm for Bitcoins is done by signing the header of each message. Every miner gets a header to sign from a pool which distributes headers to a group of miners. The miner needs to perform the following Hash function in order to find a signature of the header as shown in Equation 1 below:

Signature=SHA256(SHA256(Block_Header)) Eq. (1)

The function SHA256 produces a hash with 256 bits. After finding the signature, the miner can know if the header is a valid header and can be sent to the network as a successful transaction. There are very rare cases where the header is valid.

A header is valid only when the signature is smaller than the Target (Bits) in the header. The target is a 256-bit number (extremely large) that all Bitcoin clients share. The SHA-256 hash of a block's header must be lower than or equal to the current target for the block to be accepted by the network. The lower the target, the more difficult it is to generate a block.

Reference is now made to FIG. 1, which is a schematic illustration of a block header structure and the signature process. The header includes the following fields: version, previous block hash, Merkle root, timestamp, bits and nonce. SHA-256 is calculated over chunks of 512 bits. As shown in FIG. 1, the block header can be divided to two chunks adding a padding field of 384b. The first chunk (Chunk 1) includes the version, the previous block hash and a main portion (for example, 224 bits out of 256 bits) of the Merkle root hash. The second chunk (Chunk 2) may include a marginal portion of the Merkle root hash (for example, 32 bits), the timestamp, bits, nonce and the padding field. The version and the padding sections are constant. The previous block hash, the timestamp and the bits sections are changed for each new block header. The Merkle root hash can be changed by the miner within a given header by influencing the Merkle root and the nonce is the dynamic portion which is scanned by the miner in order to look for the signature.

In order to find the header structure that will create a valid signature (less than the target), the miner is allowed to change the 32b nonce value. The miner can increment the nonce value for every trial and check for a signature, in order to cover all options a 2̂32 trials are needed, which may lead to no resolution and then a new header format should be attempted. (a new header format is created by using a different Merkle root that is extracted from the list of transactions in the message).

In order to focus on the hash algorithm and optimization for the nonce scanning (2̂32 iterations), we will just assume that the miner has an option to change the Merkle root and start a new round of nonce scanning using a new header structure and look for a valid signature again.

As mentioned above, the signature is calculated by applying SHA256(SHA256(Header)). The first chunk is hashed first, providing the mid-state hash (H0). H0 is the initial vector (IV) that is used to load the initial state of the SHA of the second chunk which produces that intermediate result of the SHA(Header). This then goes to another SHA function that produces the signature. Therefore, the process involves three SHA iterations (each SHA iteration takes approximately 64 cycles). The mid-state H0 is calculated once per header, usually by the host computer. The next two hashes are the performance calculations and may be carried out by hardware acceleration.

As described above the transactions are signed using a Merkle root hash. The Merkle root can be manipulated by adding a coinbase transaction to the network transactions. As mentioned above, a coinbase transaction belongs to the miner and can be used to get the mining fees.

### SUMMARY OF THE INVENTION

Embodiments of the present invention provide a method for sharing hash calculations across N parallel mining threads, the method including: finding N Merkle root hash values that have identical marginal portions of a predetermined size, calculating by a host computer a corresponding mid-state hash for each of the N Merkle root hash values; and transmitting the N Merkle root hash values along with the corresponding mid-state values to the N parallel mining threads.

According to some embodiments of the present invention, the method may further include producing by a CPU Merkle packets that include Merkle tree branches and/or other necessary fields for Merkle root hash calculation and provides them to a Merkle generator. The Merkle generator may receive a Merkle packet from a CPU, perform a Merkle root hash algorithm and look for winner Merkle root hashes that have identical marginal portions.

According to some embodiments of the present invention, a Merkle packet may be received from a CPU and stored in a Merkle memory. Then, the Merkle memory may be read and a hash engine may be fed with Merkle branch data, each time with a new extra nonce. The Merkle memory may perform Merkle hash calculations and check, for a certain extra nonce value, if the Merkle hash value is a winner Merkle hash value. Winner Merkle hash values may be sent to a Merkle generator manager, which is further configured to send them to the CPU.

According to some embodiments of the present invention, winner Merkle hash values may be transmitted to the CPU, which may add the winner Merkle hash values to a collision table to collect batches of N Merkle Winners, and when a batch of N Merkle Winners is formed, the CPU may forward the batch to the N parallel mining threads.

According to some embodiments of the present invention, job packets may be received from the CPU and forwarded to an engine controller of a multithreading engine. The multithreading engine may produce signatures by iterations over a defined range of nonces; and for a produced signature, may check if the signature is valid.

According to some embodiments of the present invention, the producing of signatures further includes producing N first-stage hashes respective to received N different mid-states and producing a signature by a second-stage hash for one of the N first-stage hashes. The producing of signatures may be performed by N parallel processes, wherein in each of the N parallel processes, a signature is produced by a second-stage hash for one of the N first-stage hashes.

Embodiments of the present invention provide a system for sharing hash calculations across N parallel mining threads, the system including a central processing unit (CPU), the CPU includes a Merkle generator to find N Merkle root hash values that have identical marginal portions of a predetermined size and calculate a corresponding mid-state hash for each of the N Merkle root hash values. The CPU may produce Merkle packets that include Merkle tree branches and provides them to the Merkle generator. The Merkle generator may receive a Merkle packet from the CPU, perform a Merkle root hash algorithm and look for winner Merkle root hashes that have identical marginal portions.

The system according to embodiments of the present invention may further include an N-thread parallel engine to process the N Merkle root hash values in parallel.

According to embodiments of the present invention, the Merkle generator may include a Merkle generator manager configured to initiate a Merkle scan process, a Merkle memory, wherein the Merkle generator is configured to receive a Merkle packet from the CPU and store it in the Merkle memory, a block feeder and a hash engine, wherein the block feeder is configured to read the Merkle memory and feed the hash engine with Merkle branch data, each time with a new extra nonce, and wherein the hash engine is configured to perform Merkle hash calculations and check, for a certain extra nonce value, if the Merkle hash value is a winner Merkle hash value, and to send winner Merkle hash values to the Merkle generator manager, which is further configured to send them to the CPU.

According to embodiments of the present invention, the N-thread parallel engine may include an engines manager and at least one multithreading engine, including an engine controller and an engine core, wherein the engines manager is configured to receive job packets from the CPU and to forward the job packets to the engine controller, and wherein the engine core is configured to receive the respective N different mid-states along with the shared marginal portion and to produce signatures by iterations over a defined range of nonces.

### BRIEF DESCRIPTION OF THE DRAWINGS

For a better understanding of embodiments of the invention and to show how the same may be carried into effect, reference will now be made, purely by way of example, to the accompanying drawings in which like numerals designate corresponding elements or sections throughout.

In the accompanying drawings:

FIG. 1 is a schematic illustration of a block header structure and the signature process in accordance with the prior art;

FIG. 2 is a schematic flowchart illustration of a method for sharing hash calculations across N parallel mining engines, according to some embodiments of the present invention;

FIG. 3 is a schematic illustration of a system for sharing hash calculations across N parallel mining engines, according to some embodiments of the present invention;

FIG. 4 is an exemplary schematic illustration of a Merkle packet that is provided by the CPU to the Merkle generator according to some embodiments of the present invention;

FIG. 5 is a schematic illustration of a Merkle generator according to some embodiments of the present invention;

FIG. 6 is a schematic illustration of a method for handling winner Merkle hash values according to some embodiments of the present invention;

FIG. 7 is a schematic illustration of an exemplary mining engines system according to some embodiments of the present invention; and

FIG. 8 is a schematic flowchart illustration of a mining process according to some embodiments of the present invention.

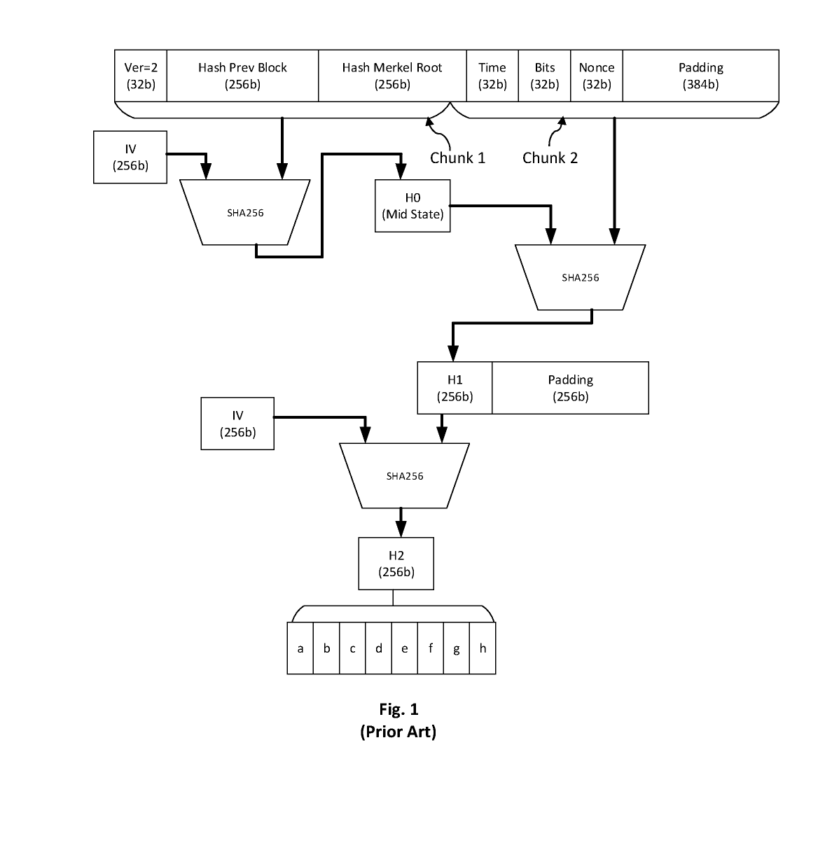

The drawings together with the following detailed description make apparent to those skilled in the art how the invention may be embodied in practice.

### DETAILED DESCRIPTION OF THE INVENTION

With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

Before explaining at least one embodiment of the invention in detail, it is to be understood that the invention is not limited in its application to the details of construction and the arrangement of the components set forth in the following description or illustrated in the drawings. The invention is applicable to other embodiments or of being practiced or carried out in various ways. Also, it is to be understood that the phraseology and terminology employed herein is for the purpose of description and should not be regarded as limiting.

Embodiments of the present invention provide a system and method for parallel processing of shared data across hash engines, thus providing a more efficient mining process that consumes less processing power and/or enables faster mining with the same processing power.

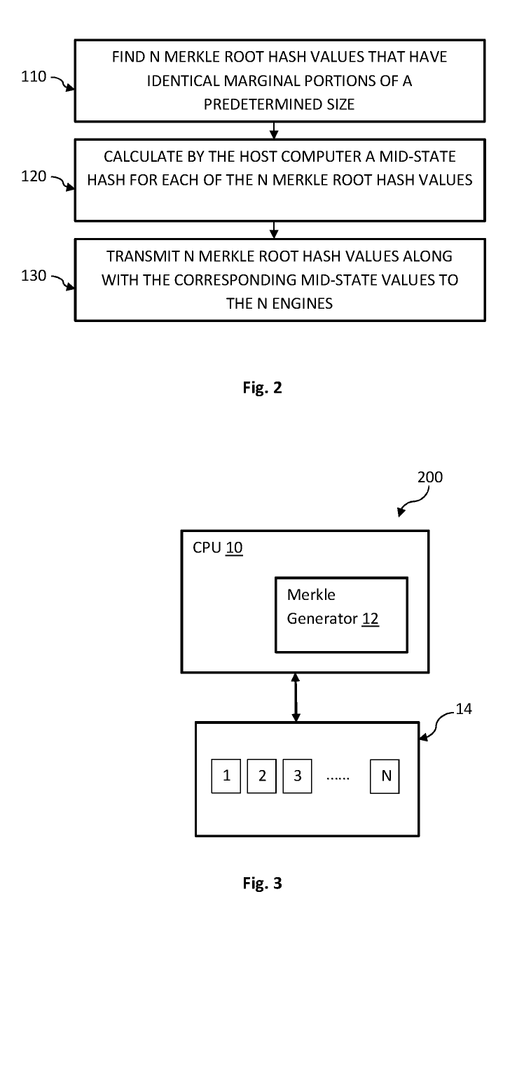

Reference is now made to FIG. 2, which is a schematic flowchart illustration of a method for sharing hash calculations across N parallel mining engines, according to some embodiments of the present invention. As discussed above, the block header is divided to two chunks, and a hash Merkle root is divided between the two chunks. The first chunk includes a main portion of the hash Merkle root and the second chunk includes a marginal portion of the hash Merkle root of a predetermined size, for example the last 32 bits of the hash Merkle root.

The method may include, as indicated in block 110, finding N Merkle root hash values that have identical marginal portions of a predetermined size. Since the identical marginal portions are included in the second header chunk, while the main, varying, portion of the

Merkle root hash values are included in the first header chunk, a different mid-state hash may be calculated by the host computer for each of the N Merkle root hash values, as indicated in block 120. Then, as indicated in block 130, the N Merkle root hash values may be transmitted along with the corresponding mid-state values to the N engines (or to an engine that can support the N mining threads in parallel). Alternatively, in some embodiments, the engines may receive along with the corresponding mid-state values only the corresponding marginal portion of the Merkle root hash values instead of receiving the entire hash Merkle root values.

In the hashing process by the engine, the data being processed is the second chunk of the block header, which may be shared by the parallel engines/threads, for example by shared data pipe, e.g. shared expander logic. Since the marginal portion of the Merkle root hash values is shared between the parallel engines/threads, each of the parallel engines, or each of the parallel mining threads, has a reduced amount of data to process and thus, for example, requires less processing power. For example, when shared between N engines, the required expander logic is reduced by (N−1)/N.

Reference is now made to FIG. 3, which is a schematic illustration of a system 200 for sharing hash calculations across N parallel mining engines, according to some embodiments of the present invention. The system may include a central processing unit (CPU) 10 that includes a Merkle generator 12, which may be software or hardware, such as a Merkle root hash application-specific integrated circuit (ASIC). The system further includes N parallel mining engines 14 (or an N-thread parallel engine 14).

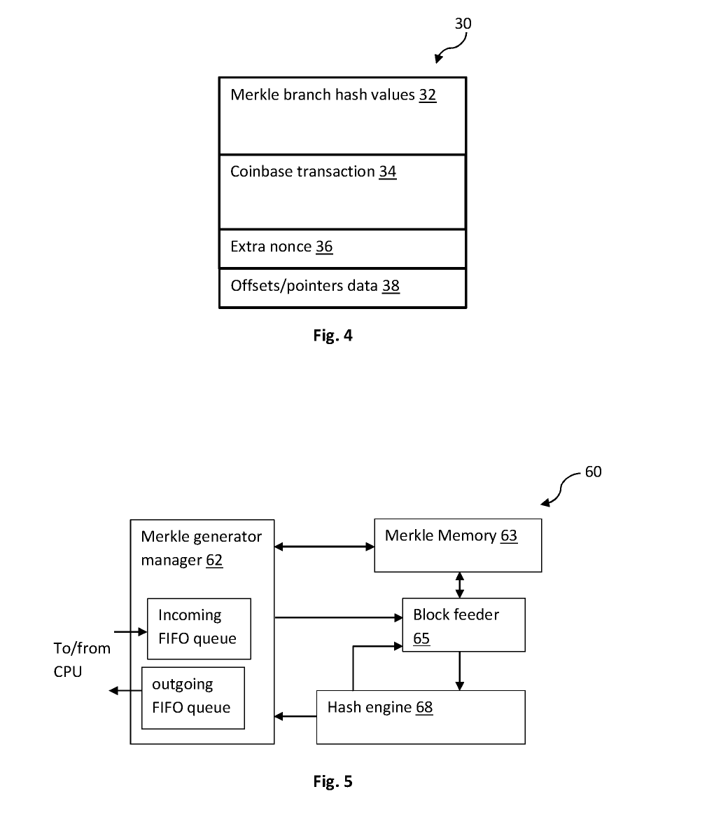

CPU 10 produces Merkle packets that include Merkle tree branches and provides them to Merkle generator 12. FIG. 4 is an exemplary schematic illustration of a Merkle packet 30 that is provided by the CPU to the Merkle generator according to some embodiments of the present invention. Merkle packet 30 may include Merkle branch hash values 32, chunks of the coinbase transaction 34, extra nonce 36 that is used by the Merkle generator to scan for collisions, and some additional required data 38 such as, for example, offsets and pointers used for orientation within the packet.

Merkle generator 12 may receive a Merkle packet from CPU 10, perform a Merkle root hash algorithm and look for Merkle root hashes that have a collision potential. A collision may occur, for example, whenever a marginal portion of the Merkle root hash value equals a certain predetermined value, and thus, for example, Merkle generator 12 can find N hash Merkle root values with the same marginal portion. Such hash Merkle root hash values may be defined as “winner” or “win” Merkle hash values. In some embodiments, a Merkle hash is considered a win Merkle hash if the K MSbits (most significant bits) of the marginal portion equal a certain predetermined value.

Reference is now made to FIG. 5, which is a schematic illustration of a Merkle generator 60 according to some embodiments of the present invention. The Merkle generator may include a Merkle generator manager 62, a Merkle memory 63, a block feeder 65 and a hash engine 68. Merkle generator 60 may receive a Merkle packet as described in detail above, including a Merkle branch and a coinbase transaction, and save the data in Merkle memory 63. Merkle generator manager 62 may initiate the Merkle scan process. In the scan process, block feeder 65 may read Merkle memory 63 and feed hash engine 68 with new Merkle branch data, each time with a new extra nonce. Hash engine 68 may perform Merkle hash calculations and check, for a certain extra nonce value, if the Merkle hash value is a win Merkle hash value. The win Merkle hash values are sent to Merkle generator manager 62, which sends them by a FIFO queue to the CPU.

Reference is now made to FIG. 6, which is a schematic illustration of a method for handling winner Merkle hash values according to some embodiments of the present invention. As shown in block 510, each time a winner Merkle hash value is found, it is added to a queue, for example, a first in first out (FIFO) queue, to be transferred to the CPU. A found winner Merkle hash value is sent to the CPU in a winner packet including the winner Merkle branch hash value and the respective extra nonce, or only the marginal portion of the winner Merkle branch hash value and the respective extra nonce.

As shown in block 520, once received by the CPU, the CPU adds the winner Merkle hash value to a collision table, to collect batches of N Merkle Winners. As shown in block 530, when a batch of N Merkle Winners is formed, the batch is forwarded to the N parallel mining engines shown in FIG. 3. The CPU collects winner Merkle hash values and once N winner Merkle hash values are found, the CPU sends a job packet to the N engines (or an engine supporting N parallel jobs), the job packet includes the respective N different mid-states along with the N winner Merkle hash values or along with the marginal portions only, for example with identifications of the respective Merkle hash values, such as the respective extra nonces. Additionally, in some embodiments of the present invention, a job packet may include a nonce range for the engines to scan. Additionally a job packet may include the additional block header data.

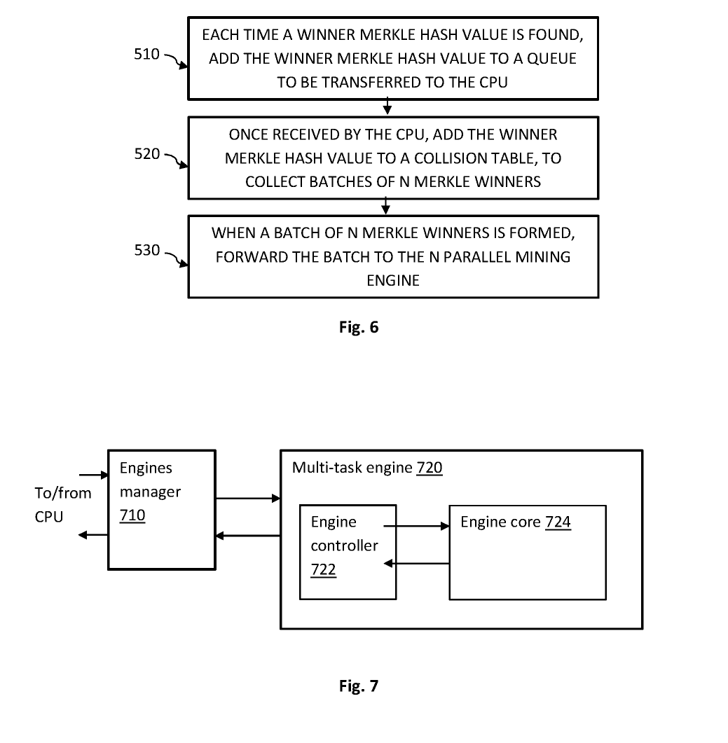

Reference is now made to FIG. 7, which is a schematic illustration of an exemplary mining engines system 700 according to some embodiments of the present invention. Mining engines system 700 may include an engines manager 710 and at least one multithreading engine 720, i.e. an engine that supporting N parallel jobs. System 700 may include, for example, up to 64 such multithreading engines. Multithreading engine 720 may include an engine controller 722 and engine core 724.

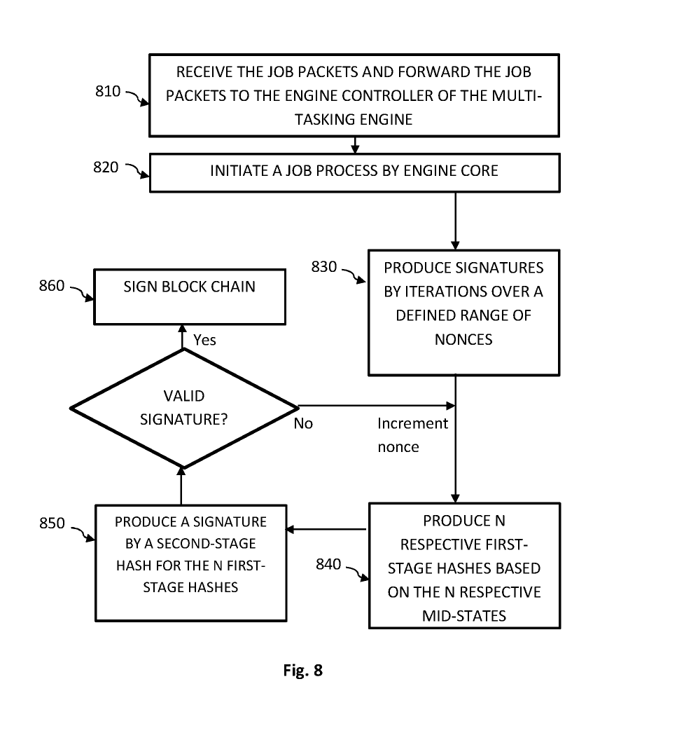

Reference is now made to FIG. 8, which is a schematic flowchart illustration of a mining process according to some embodiments of the present invention. As indicated in block 810, engines manager 710 may receive the job packets and forward the job packets to engine controller 722 of multithreading engine 720, for example by a FIFO queue. As indicated in block 820, engine controller 722 may initiate a job process by engine core 724. As indicated in block 830, engine core 724 may receive the respective N different mid-states along with the shared marginal portion and produce signatures by iterations over a defined range of nonce values. For a certain nonce value, two stages may be performed. As indicated in block 840, in a first stage N respective first-stage hashes are produced, for example in parallel, based on the N respective mid-states and using a shared data pipe (e.g., shared expander logic) between the N parallel threads. As indicated in block 850, a second stage of the process may include N parallel processes. In each of the N parallel processes, the engine core may produce a signature by a second-stage hash for one of the N first-stage hashes. In the second stage, a full process is done without sharing of data. As indicated in block 860, in case the signature is valid, the block chain may be signed. Then, the nonce is incremented and the process returns to the first stage, in which N respective first-stage hashes are produced and so on.

In the above description, an embodiment is an example or implementation of the inventions. The various appearances of “one embodiment,” “an embodiment” or “some embodiments” do not necessarily all refer to the same embodiments.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

The principles and uses of the teachings of the present invention may be better understood with reference to the accompanying description, figures and examples.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

The descriptions, examples, methods and materials presented in the claims and the specification are not to be construed as limiting but rather as illustrative only.

Meanings of technical and scientific terms used herein are to be commonly understood as by one of ordinary skill in the art to which the invention belongs, unless otherwise defined.

The present invention may be implemented in the testing or practice with methods and materials equivalent or similar to those described herein.

While the invention has been described with respect to a limited number of embodiments, these should not be construed as limitations on the scope of the invention, but rather as exemplifications of some of the preferred embodiments. Other possible variations, modifications, and applications are also within the scope of the invention.

1. A method for sharing hash calculations across N parallel mining threads, the method comprising:
finding N Merkle root hash values that have identical marginal portions of a predetermined size;
calculating a corresponding mid-state hash for each of the N Merkle root hash values; and
transmitting the N Merkle root hash values along with the corresponding mid-state values to the N parallel mining threads.

2. The method according to claim 1, further comprising producing by a CPU Merkle packets that include Merkle tree branches and provides them to a Merkle generator.

3. The method according to claim 1, further comprising receiving by a Merkle generator a Merkle packet from a CPU, performing a Merkle root hash algorithm and looking for winner Merkle root hashes that have identical marginal portions.

4. The method according to claim 3, further comprising:
receiving a Merkle packet from a CPU and storing it in a Merkle memory;
reading the Merkle memory and feeding a hash engine with Merkle branch data, each time with a new extra nonce;
performing Merkle hash calculations and checking, for a certain extra nonce value, if the Merkle hash value is a winner Merkle hash value; and
sending winner Merkle hash values to a Merkle generator manager, which is further configured to send them to the CPU.

5. The method according to claim 3, further comprising:
transmitting winner Merkle hash values to the CPU;
adding the winner Merkle hash values to a collision table to collect batches of N Merkle Winners; and
when a batch of N Merkle Winners is formed, forwarding the batch to the N parallel mining threads.

6. The method according to claim 1, further comprising:
receive job packets from the CPU and to forward the job packets to an engine controller of a multithreading engine;
producing signatures by iterations over a defined range of nonces; and
for a produced signature, checking if the signature is valid.

7. The method according to claim 6, wherein the producing of signatures further comprises:
producing N first-stage hashes respective to received N different mid-states; and
producing a signature by a second-stage hash for at least one of the N first-stage hashes.

8. A system for sharing hash calculations across N parallel mining threads, the system comprising:
a central processing unit (CPU), the CPU comprises a Merkle generator to find N Merkle root hash values that have identical marginal portions of a predetermined size and calculate a corresponding mid-state hash for each of the N Merkle root hash values; and
an N-thread parallel engine to process the N Merkle root hash values in parallel.

9. The system according to claim 9, wherein the CPU produces Merkle packets that include Merkle tree branches and provides them to the Merkle generator.

10. The system according to claim 9, wherein the Merkle generator receives a Merkle packet from the CPU, performs a Merkle root hash algorithm and looks for winner Merkle root hashes that have identical marginal portions.

11. The system according to claim 9, wherein the Merkle generator comprises:
a Merkle generator manager configured to initiate a Merkle scan process;
a Merkle memory, wherein the Merkle generator is configured to receive a Merkle packet from the CPU and store it in the Merkle memory;
a block feeder; and
a hash engine, wherein the block feeder is configured to read the Merkle memory and feed the hash engine with Merkle branch data, each time with a new extra nonce, and wherein the hash engine is configured to perform Merkle hash calculations and check, for a certain extra nonce value, if the Merkle hash value is a winner Merkle hash value, and to send winner Merkle hash values to the Merkle generator manager, which is further configured to send them to the CPU.

12. The system according to claim 9, wherein the N-thread parallel engine comprises:
an engines manager; and
at least one multithreading engine, comprising:
an engine controller; and
an engine core,
wherein the engines manager is configured to receive job packets from the CPU and to forward the job packets to the engine controller, and wherein the engine core is configured to receive the respective N different mid-states along with the shared marginal portion and to produce signatures by iterations over a defined range of nonces.
